(19) United States
(12) Patent Application Publication
(10) Pub. No.: US 2026/0184850 A1
(43) Pub. Date: Jul. 2, 2026

(54) BIODEGRADABLE POLYURETHANE AND METHOD FOR PREPARING THE SAME

(71) Applicants: Hyundai Motor Company, Seoul (KR); Kia Corporation, Seoul (KR); Inha University Research and Business Foundation, Incheon (KR)

(72) Inventors: Kwon Yong Choi, Hwaseong (KR); Hee Joong Kim, Seoul (KR); Seon Min Jin, Incheon (KR); Hye In Kim, Incheon (KR)

(21) Appl. No.: 19/229,235

(22) Filed: Jun. 5, 2025

(30) Foreign Application Priority Data
Dec. 30, 2024 (KR) 10-2024-0200935

(51) Int. Cl. C08G 71/04; C08K 5/29; C08K 5/38

(52) U.S. Cl. CPC C08G 71/04; C08K 5/29; C08K 5/38

(57) ABSTRACT

Provided is a method for preparing biodegradable polyurethane, which includes preparing a first polyol having a linear structure by polymerizing a first cyclic monomer containing a heteroatom, in presence of a bifunctional initiator, preparing a second polyol containing a cyclic structure by polymerizing a second cyclic monomer containing a heteroatom, in presence of a chain transfer agent, and allowing the first polyol having the linear structure, the second polyol containing the cyclic structure, and an isocyanate-based compound to react with each other.

### CROSS-REFERENCE TO RELATED APPLICATION

This application claims under 35 U.S.C. § 119(a) the benefit of Korean Patent Application No. 10-2024-0200935, filed in the Korean Intellectual Property Office on Dec. 30, 2024, the entire contents of which are incorporated herein by reference.

### BACKGROUND

### Technical Field

The present disclosure relates to biodegradable polyurethane, which is eco-friendly and exhibits an excellent mechanical and/or chemical property, as the biodegradable polyurethane is prepared using a biodegradable source material to exhibit biodegradability, and a method for preparing the same.

### Background

Concerns about environmental pollution caused by plastic waste have been raised, and social awareness of this issue has increased. Accordingly, regulations against the environmental pollution have been internationally expanded. In compliance with such international regulations, the demand for eco-friendly plastic has been increased. The eco-friendly plastic includes, for example, recycled plastic obtained by recycling wasted plastic, or biodegradable plastic which is easily degradable.

Meanwhile, polyurethane, which is generally a thermosetting resin synthesized from a petrochemical source material, is excellent in various mechanical properties, such as elasticity, durability, chemical resistance, or strength. Accordingly, the polyurethane has been extensively used as a material in various fields. Such chemically-synthesized polyurethane is difficult to degrade and/or recycle due to its high chemical resistance, and especially, polyurethane foam is challenging to discard as waste, due to its lower density.

As an alternative to this problem, a previously disclosed polyurethane foam composition for vehicle seats include an eco-friendly polyurethane foam composition for a vehicle seat, which includes resin premix containing polyol, catalyst, tablet, and a foaming agent including at least one selected from the group consisting of modified polyol and polyether polyol obtained from vegetable triglyceride; and isocyanate. However, a conventional biodegradable plastic may not serve as a direct substitute for plastics synthesized from petrochemical sources because it may lack sufficient mechanical or chemical properties such as impact resistance, when compared to plastic synthesized from a petrochemical source material. In addition, since the most parts of conventional biodegradable plastics are synthesized from a large number of source materials, the conventional biodegradable plastics are substantially random copolymers. Such random copolymers have a difficulty when being processed. In addition, it is difficult to control the physical property of a polymer prepared by adjusting a source material.

Accordingly, research and development are needed to establish a method for preparing polyurethane which is eco-friendly, exhibits an excellent mechanical and/or chemical property, while also allowing the physical properties of the resulting polymer to be controlled by using biodegradable source materials that impart biodegradability.

### SUMMARY

At least some embodiments of the present disclosure have been made to solve the above-mentioned problems occurring in the existing technologies while advantages achieved by the existing technologies are maintained intact.

An embodiment of the present disclosure provides biodegradable polyurethane, which is eco-friendly, exhibits an excellent mechanical and/or chemical property, and facilitates the control of the physical property of a polymer prepared, as the biodegradable polyurethane is prepared using a biodegradable source material to exhibit biodegradability, and a method for preparing the same.

The technical problems to be solved by at least some embodiments of the present disclosure are not limited to the aforementioned problems, and any other technical problems not mentioned herein will be clearly understood from the following description by those skilled in the art to which the present disclosure pertains.

According to an embodiment of the present disclosure, a method for preparing biodegradable polyurethane includes preparing a first polyol having a linear structure by polymerizing a first cyclic monomer containing a heteroatom and being degradable, in presence of a bifunctional initiator (S10),
preparing a second polyol containing a cyclic structure by polymerizing a second cyclic monomer containing a heteroatom and having biodegradability, in presence of a chain transfer agent (S20), and
allowing the first polyol having the linear structure, the second polyol containing the cyclic structure, and an isocyanate-based compound to react with each other (S30).

According to an embodiment of the present disclosure, biodegradable polyurethane includes a repeating unit represented by following Chemical formula 3,

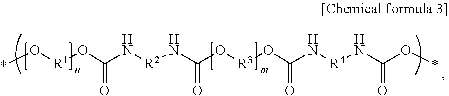

in which in Chemical formula 3,
R¹ is a linear alkylene group,
each of R² and R⁴ is an independently substituted or unsubstituted alkylene or alkenylene group,
R³ is an alkylene group containing a heterocyclic group,
n is a real number greater than 10 and less than 200, and
m is a real number greater than 10 and less than 200.

In some embodiments, provided is a biodegradable polyurethane comprising: at least 75 wt % biomass-derived carbon, based on a total weight of the polyurethane, and a repeating unit represented by the following Chemical formula 3,

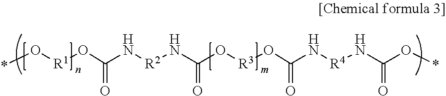

wherein:
R¹ is a linear alkylene group,
each of R² and R⁴ is an independently substituted or unsubstituted alkylene or alkenylene group,
R³ is an alkylene group containing a heterocyclic group,
n is a real number greater than 10 and less than 200, and
m is a real number greater than 10 and less than 200.

The heterocyclic ring in R³ may be selected from the group consisting of a furan ring, a tetrahydrofuran ring, a pyran ring, a thiophene ring, and a pyrrole ring.

The polyurethane may be formed by reacting: an isocyanate-based compound, a first polyol having a linear structure, and a second polyol having a cyclic structure, each of the first polyol and second polyol being derived from a cyclic monomer containing a heteroatom and having biodegradability.

The second polyol may be prepared by polymerizing a cyclic monomer selected from the group consisting of 2,3-dihydrofuran and 3,4-dihydro-2H-pyran, in the presence of a chain transfer agent.

Each of R² and R⁴ may be independently a linear or branched alkylene group having 2 to 8 carbon atoms.

Also provided is a material for mobility comprising the biodegradable polyurethane.

### BRIEF DESCRIPTION OF THE DRAWINGS

The above and other objects, features and advantages of the present disclosure will be more apparent from the following detailed description taken in conjunction with the accompanying drawings:

FIG. 1 illustrates an analysis result of a first oligomer, according to some embodiments of the present disclosure;

FIG. 2 is a graph illustrating a result obtained by measuring a conversion for converting a first oligomer into a first polyol having a linear structure, as a function of a reaction time, according to some embodiments of the present disclosure;

FIG. 3 is an NMR graph of a first polyol having a linear structure, according to some embodiments of the present disclosure;

FIG. 4 is a graph illustrating the change in a conversion, as a function of a total reaction time, according to some embodiments of the present disclosure;

FIG. 5 is a graph illustrating the change in a molecular weight of a first polyol having a linear structure prepared in a ratio of a first cyclic monomer (DHF) and a bifunctional initiator (I), according to some embodiments of the present disclosure;

FIG. 6 is a TGA (thermogravimetric analysis) curve depicting the thermal degradation profile of the first polyol having a linear structure, according to some embodiments of the present disclosure;

FIG. 7 is a DSC (differential scanning calorimetry) graph showing the glass transition temperature of the first polyol having a linear structure, according to some embodiments of the present disclosure;

FIG. 8 is an FT-IR spectrum of the first polyol having a linear structure, illustrating its characteristic functional groups, according to some embodiments of the present disclosure;

FIG. 9 illustrates an analysis result of a second oligomer, according to some embodiments of the present disclosure;

FIG. 10 illustrates an analysis result of a second polyol containing a cyclic structure, according to some embodiments of the present disclosure;

FIG. 11 illustrates an analysis result of polyurethane prepared in Preparation example 3;

FIG. 12 illustrates photographs illustrating the external appearance of the polyurethane foam prepared according to some embodiments of the present disclosure;

FIG. 13 illustrates SEM photographs showing pores formed within the polyurethane foam, according to some embodiments of the present disclosure;

FIG. 14 is a graph showing the compressive strength of polyurethane foams, prepared in Preparation Example 3 and Embodiments 1-4, as measured by a universal testing machine;

FIG. 15 is a graph illustrating hysteresis loss and sag factor results for the polyurethane foams, demonstrating how these properties vary with the ratio of first polyol (linear) to second polyol (cyclic);

FIG. 16 is a graph illustrating an FT-IR analysis result of polyurethane foam, according to some embodiments of the present disclosure;

FIG. 17 is a set of images depicting the extent of polyurethane degradation after immersion in acidic or neutral solutions for specified time intervals, according to some embodiments of the present disclosure; and

FIG. 18 is a set of images showing that the polyurethane foam according to Embodiment 1 undergoes progressive degradation after immersion in 0.1M aqueous hydrochloric acid, according to some embodiments of the present disclosure.

### DETAILED DESCRIPTION

In the present specification, a part “comprising” a certain component refers to that the part further comprises other components, instead of excluding other components unless specifically opposed.

In addition, in this specification, a “weight-average molecular weight”, which is measured through an ordinary manner well-known in the art, may be measured, for example, through a gel permission chromatography (GPC) manner.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The term “biodegradable” as used herein refers to a property of a polymer or material that is capable of being decomposed by microorganisms, enzymes, or other natural environmental processes (e.g., hydrolysis) under specified conditions, resulting in its breakdown into simpler substances or biomass over a relatively short period.

The term “biomass-derived carbon” as used herein refers to carbon atoms originating from renewable biological sources, such as plants or other organic matter, rather than from fossil-based feedstocks (e.g., petroleum, coal, natural gas).

The alkylene group includes a bivalent radical of a branched chain, a linear chain, or a cyclic group, which is derived by removing one hydrogen atom from a carbon atom of an alkyl group. The term “alkylene”, as used herein, can represent a saturated divalent straight or branched chain hydrocarbon group and is exemplified by methylene, ethylene, isopropylene, other specific groups disclosed herein and the like. The term “alkenylene” as used herein includes an unsaturated divalent straight or branched chain hydrocarbon group having one or more unsaturated carbon-carbon double bonds that may occur in any stable point along the chain.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

### Method for Preparing Biodegradable Polyurethane

According to the present disclosure, the method for preparing biodegradable polyurethane includes the steps for preparing a first polyol having a linear structure by polymerizing a first cyclic monomer containing a heteroatom and having biodegradability, in the presence of a bifunctional initiator (S10); for preparing a second polyol containing a cyclic structure by polymerizing a second cyclic monomer containing a heteroatom and being biodegradable, in the presence of a chain transfer agent (S20); and for allowing the first polyol having the linear structure, the second polyol containing the cyclic structure, and an isocyanate-based compound to react with each other (S30).

In this case, each of ‘S10’ and ‘S20’ may be performed separately, simultaneously, sequentially, or in reverse order. In other words, the first polyol having the linear structure and the second polyol containing the cyclic structure may be prepared simultaneously, the second polyol having the cyclic structure may be prepared after preparing the first polyol having the linear structure, or the first polyol having the linear structure may be prepared after preparing the second polyol containing the cyclic structure.

### Preparing First Polyol Having Linear Structure (S10)

In the present step, the first polyol having the linear structure is prepared by polymerizing the first cyclic monomer containing the heteroatom and being biodegradable, in the presence of the bifunctional initiator.

Since the first cyclic monomer is a biomass-based source material and biodegradable, the first cyclic monomer imparts biodegradability to the first polyol having the linear structure to be prepared, thereby improving biodegradability of the polyurethane prepared.

The bifunctional initiator forms a main chain of the first polyol having the linear structure which is prepared, as the bifunctional initiator polymerizes with the first cyclic monomer, and allows the first polyol prepared to easily have hydroxyl groups at opposite terminals of the first polyol prepared.

Specifically, S10, which is the present step, may include the steps for preparing a first oligomer containing an ester group at a terminal of the first oligomer by polymerizing the first cyclic monomer containing the heteroatom and being biodegradable, in the presence of the bifunctional initiator (S11) and for preparing the first polyol having the linear structure by reducing the ester group at the terminal of the first oligomer to a hydroxyl group (S12).

### <S11>

The polymerization reaction in S11 may be performed under a grubbs catalyst. In other words, the polymerization reaction in S11 may be a ring-opening metathesis polymerization (ROMP) reaction. For example, the polymerization reaction in S11 may be performed at a temperature of −20° C. to 60° C. under the grubbs catalyst. Specifically, the polymerization reaction in S11 may be performed at a temperature of at least −10° C., at least −5° C., at most 40° C., or at most 35° C. under the grubbs catalyst.

The grubbs catalyst may include various grubbs catalysts, which are typically purchased and obtained, without a special limitation. For example, the grubbs catalyst is a third generation (3^{rd}) grubbs catalyst, but the present disclosure is not limited thereto.

In addition, the polymerization reaction in S11 may be performed for at least two hours, at least 2.5 hours, at least three hours, at most sixth hours, or at most 5.5 hours, at most five hours.

The first cyclic monomer may include various monomers which have a cyclic structure containing a heteroatom, have biodegradability, and participate in the polymerization reaction. For example, the first cyclic monomer may be selected from the group consisting of 2,3-dihydrofuran, and 3,4-dihydro-2H-pyran. Specifically, the first cyclic monomer may include 2,3-dihydrofuran. When the first cyclic monomer includes 2,3-dihydrofuran, a glass transition temperature of the first polyol prepared is increased, to reduce an isocyanate content, thereby improving environment-friendliness.

The bifunctional initiator may include a linear third monomer including vinyl ether groups at opposite terminals of the linear third monomer. For example, the linear third monomer may be linear alkylene including vinyl ether groups at opposite terminals of the linear alkylene. Specifically, the third monomer may include a structure represented by following Chemical formula 4.

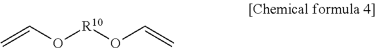

In Chemical formula 4, R¹⁰ may be an alkylene group having 1 to 15 carbon atoms or an alkylene group having 1 to 6 carbon atoms. Specifically, R¹⁰ may include methylene (—CH₂—), 1,1-ethylene (—CH(CH₃)—), 1,2-ethylene (—CH₂CH₂—), 1,3-propylene (—CH₂CH₂CH₂—), 1,4-butylene (—CH₂CH₂CH₂CH₂—), or 2,4-butylene (—CH₂(CH₃)CH₂CH₂—), but the present disclosure is not limited thereto. In addition, the alkylene group refers to a bivalent radical of a branched chain, a linear chain, or a cyclic group, which is derived by removing one hydrogen atom from a carbon atom of an alkyl group.

The ester group present at each of the opposite terminals of the first oligomer prepared in S11 may include a formate group (—OCHO). Specifically, the first oligomer may include a structure represented by following Chemical formula 5.

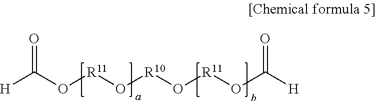

In Chemical formula 5, R¹⁰ may be a unit derived from the bifunctional initiator. For example, R¹⁰ may be an alkylene group having 1 to 15 carbon atoms or an alkylene group having 1 to 6 carbon atoms.

R¹¹ may be a unit derived from the first cyclic monomer. For example, R¹¹ may be an alkylene group having 1 to 10 carbon atoms or an alkylene group having 1 to 6 carbon atoms.

In Chemical formula 5, ‘a’ may be a real number greater than or equal to 10 and less than or equal to 200.

In Chemical formula 5, ‘b’ may be a real number greater than or equal to 10 and less than or equal to 200.

### <S12>

In the present step, the first polyol having the linear structure may be prepared by reducing the ester group (especially, the formate group (—OCHO)) present at the terminal of the first oligomer, to the hydroxyl group.

The reduction may be performed using a basic nucleophilic compound. In this case, the basic nucleophilic compound may include a nitrogen-based compound having 1 to 10 carbon atoms or a non-ferrous metal-based hydroxide which does not contain carbon. Specifically, the basic nucleophilic compound may include triethyleneamine, sodium hydroxide, sodium methyloxy, or sodium bicarbonate (Na₂HCO₃).

In addition, the reduction may be performed at, for example, the temperature of at least 15° C., at least 20° C., at most 60° C., or at most 50° C. for at least 4 hours, at least 5 hours, at most 10 hours, or at most 8 hours, but the present disclosure is not limited thereto.

The first polyol having the linear structure prepared through the above-described manner may have a glass transition temperature (Tg) of at least −100° C., at least −80° C., at least −70° C., at least −60° C., at least −55° C., at most −20° C., at most −30° C., at most −35° C., or at most −40° C. Accordingly, the first polyol having the linear structure may be a soft segment of the polyurethane prepared from the first polyol.

In addition, the first polyol having the linear structure may include a structure represented by Chemical formula 6.

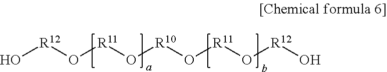

In Chemical formula 6, R¹⁰, R¹¹, a, and b are defined as in Chemical formula 5.

In addition, R¹² may include a unit derived from the alcohol-based compound, and for example, may be an alkylene group having 1 to 10 carbon atoms, an alkylene group having 1 to 5 carbon atoms, or an alkylene group having 1 to 3 carbon atoms.

### Preparing Second Polyol (S20)

In the present step, the second polyol containing the cyclic structure is prepared by polymerizing the second cyclic monomer containing the heteroatom and being biodegradable, in the presence of the chain transfer agent. In this case, the polymerization reaction in the present step may be a reversible addition fragmentation chain transfer (RAFT) polymerization reaction.

Since the second cyclic monomer is a biomass-based source material and is biodegradable, biodegradability is imparted to the prepared second polyol containing the cyclic structure, thereby improving biodegradability to the polyurethane.

Specifically, S20, which is the present step, may include the steps for preparing a second oligomer containing a functional group, which is represented by following Chemical formula 2, at an terminal of the second oligomer, by polymerizing the second cyclic monomer containing the heteroatom and being biodegradable, in the presence of the chain transfer agent (S21), and preparing the second polyol containing the cyclic structure by modifying a terminal group of the second oligomer to a hydroxyl group (S22).

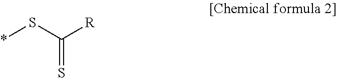

In Chemical formula 2, R is a substituted or unsubstituted alkyl group.

### <S21>

In S21, the second oligomer containing the functional group, which is represented by Chemical formula 2, at the terminal of the second oligomer may be prepared by polymerizing the second cyclic monomer containing the heteroatom and being biodegradable, in the presence of the chain transfer agent.

In addition, the polymerization reaction in S21 may be performed at a temperature of at least −50° C., at least −45° C., at most −30° C., or at most −35° C., for at least 10 minutes, at least 20 minutes, at most 60 minutes, or at most 45 minutes, but the present disclosure is not limited thereto.

The second cyclic monomer may include various cyclic monomers which containing a cycling structure containing a heteroatom, has biodegradability, and is able to participate in the polymerization reaction in S1. For example, the second cyclic monomer may be selected from the group consisting of 2,3-dihydrofuran and 3,4-dihydro-2H-pyran. Specifically, the second cyclic monomer may include 2,3-dihydrofuran. When the second cyclic monomer includes 2,3-dihydrofuran, a glass transition temperature of the second polyol prepared is increased to reduce the content of isocyanate, thereby improving environment-friendliness.

In addition, the first cyclic monomer and the second cyclic monomer may employ the same compound. When the first cyclic monomer and the second cyclic monomer employ the same compound, the physical property of the polyurethane to be prepared may be more easily controlled, and economic feasibility may be improved by lowering preparation costs.

The chain transfer agent may be prepared by allowing a linear fourth monomer containing vinyl groups present at opposite terminals of the linear fourth monomer to react with a thiocarbonylthio-based compound.

The fourth monomer may include various monomers which contain vinyl groups at the opposite terminals of the fourth monomer, have a linear structure, and are able to participate in a polymerization reaction. For example, the fourth monomer may be linear deoxyalkylene containing vinyl groups at opposite terminals of deoxyalkylene. Specifically, the fourth monomer may include a structure represented by following Chemical formula 7.

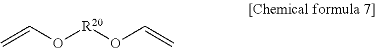

In Chemical formula 7, R²⁰ may be an alkylene group having 1 to 15 carbon atoms or an alkylene group having 1 to 6 carbon atoms. Specifically, R²⁰ may include methylene (—CH₂—), 1,1-ethylene (—CH(CH₃)—), 1,2-ethylene (—CH₂CH₂—), 1,3-propylene (—CH₂CH₂CH₂—), 1,4-butylene (—CH₂CH₂CH₂CH₂—), or 2,4-butylene (—CH₂(CH₃)CH₂CH₂—), but the present disclosure is not limited thereto. As discussed, the alkylene group refers to a bivalent radical of a branched chain, a linear chain, or a cyclic group, which is derived by removing one hydrogen atom from a carbon atom of an alkyl group.

The thiocarbonylthio-based compound may be a compound including a functional group represented by Chemical formula 2.

The reaction between the fourth monomer and the thiocarbonylthio-based compound may be performed at a temperature ranging from 0° C. to 100° C. for at least 3 hours, at least 5 hours, at most 12 hours, or at most 10 hours, but the present disclosure is not limited thereto.

When employing the chain transfer agent prepared through the above manner, the reactivity of the opposite terminals may be controlled to induce a reversible addition-fragmentation chain transfer (RAFT) polymerization reaction of the second cyclic monomer, thereby preparing the second oligomer having the controlled reactivity of opposite terminals.

The chain transfer agent may be represented by following Chemical formula 1.

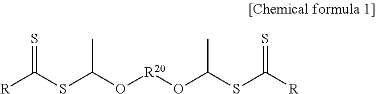

In Chemical Formula 1, R may be a substituted or unsubstituted alkyl group, for example, a substituted or unsubstituted alkyl group having 1 to 15 carbon atoms, a substituted or unsubstituted alkyl group having 1 to 10 carbon atoms, or a substituted or unsubstituted alkyl group having 2 to 6 carbon atoms. In this case, the substitution may be obtained by substituting a portion of carbon with an amino group or a thiol group, and specifically, may be obtained by substituting the portion of carbon with an amino group.

R²⁰ may be an alkylene group having 1 to 15 carbon atoms or an alkylene group having 1 to 6 carbon atoms. Specifically, the R²⁰ may include methylene (—CH₂—), 1,1-ethylene (—CH(CH₃)—), 1,2-ethylene (—CH₂CH₂—), 1,3-propylene (—CH₂CH₂CH₂—), 1,4-butylene (—CH₂CH₂CH₂CH₂—), or 2,4-butylene (—CH₂(CH₃) CH₂CH₂—), but the present disclosure is not limited thereto.

Specifically, the chain transfer agent may have a structure including a dithiocarbamate (>N—C(═S)—S—) group at opposite terminals of the chain transfer agent. In other words, in Chemical formula 1, R may be an aminoalkyl group. For example, R may be an aminoalkyl group having 1 to 15 carbon atoms, an aminoalkyl group having 1 to 10 carbon atoms, or an aminoalkyl group having 2 to 6 carbon atoms.

The second oligomer prepared through the above manner may include a structure represented by Chemical formula 8.

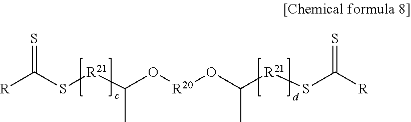

In Chemical formula 8, R and R²⁰ are defined as in Chemical formula 1.

In addition, R²¹ may be an alkylene group including a cycling group containing a heteroatom. For example, R²¹ may be a 5-membered ring or a 6-membered ring-containing alkylene group including a heteroatom, and the heteroatom may be nitrogen, sulfur, or oxygen. In detail, R²¹ may be oxolanyl.

In Chemical formula 8, ‘c’ may be a real number greater than or equal to 5 and less than or equal to 100.

In Chemical formula 8, ‘d’ may be a real number greater than or equal to 5 and less than or equal to 100.

Specifically, the second oligomer may have a structure including a dithiocarbamate group at opposite terminals of the second oligomer. In other words, in Chemical Formula 8, R may be an aminoalkyl group, such as an aminoalkyl group having 1 to 15 carbon atoms, an aminoalkyl group having 1 to 10 carbon atoms, or an aminoalkyl group having 2 to 6 carbon atoms.

### <S22>

In S22, the second polyol containing the cyclic structure is prepared by modifying a terminal group of the second oligomer to a hydroxyl group.

As illustrated in Chemical formula 8, the terminal group of the second oligomer includes a structure represented by Chemical formula 2. In other words, in the present step, the second polyol containing the cyclic structure is prepared by modifying the terminal group of the second oligomer, which is represented by Chemical formula 2, to a hydroxyl group.

Specifically, S22 may include the steps for separating the structure represented by Chemical formula 2 and present at the terminal of the second oligomer by allowing the second oligomer to react with organic acid (S22-1), and for preparing the second polyol containing the cyclic structure by introducing a hydroxyl group into the terminal group of the second oligomer using a diol-based compound (S22-2).

When the second oligomer contains a dithiocarbamate (>N—C(═S)—S—) group as the terminal group of the second oligomer, the terminal group of the second oligomer may not be reduced to a functional group, such as a thiol (—SH) group, due to high stability resulting from a unique resonance structure. In addition, even if the terminal group of the second oligomer is modified to a thiol group, a thiol-ene reaction, in which a double bond in the second oligomer reacts with the thiol group, may be induced, thereby preventing a polyurethane synthesis reaction. Accordingly, in S22-1, the terminal of the second oligomer is radicalized by separating the structure represented by Chemical formula 2 at the terminal of the second oligomer, thereby facilitating the introduction of a hydroxyl group to the terminal of the second oligomer in S22-2 subsequent and preventing the polyurethane synthesis reaction thereafter from being adversely affected.

The organic acid functions to separate the terminal structure of the second oligomer represented by Chemical formula 2.

In addition, the organic acid may be superacid. For example, the organic acid may be triflic acid, fluoroantimonic acid, magic acid, triflidic acid, carborane acid, fluoroboric acid, bistriflimide, fluorosulfuric acid, hydrogen fluoride, sulfuric acid, or perchloric acid.

S22-1 may be performed at a temperature ranging from −50° C. to −30° C. Specifically, S22-1 may be performed at a temperature of at least −48° C., at least −45° C., at least −43° C., at most −32° C., at most −35° C., or at most −38° C., but the present disclosure is not limited thereto.

Additionally, S22-1 may be performed for at least 0.5 minutes, at least 1 minute, at most 60 minutes, or at most 30 minutes, but the present disclosure is not limited thereto.

In S22-2, the second polyol containing the cyclic structure is prepared by introducing a hydroxyl group into the terminal group of the second oligomer, which is radicalized using a diol-based compound.

The diol-based compound may be a diol-based compound having 1 to 10 carbon atoms or a diol-based compound having 2 to 4 carbon atoms. For example, the diol-based compound may include ethylene glycol, propylene glycol, n-butylene glycol, or i-butylene glycol.

S22-2 may be performed at a temperature ranging from 15° C. to 35° C. For example, S22-2 may be performed at a temperature of at least 18° C., at least 20° C., at most 30° C., or at most 28° C.

In addition, S22-2 may be performed for at least 40 minutes, at least 45 minutes, at least 50 minutes, at most 75 minutes, at most 70 minutes, or at most 65 minutes, but the present disclosure is not limited thereto.

The second polyol containing the cyclic structure prepared through the above-described manner may have a glass transition temperature (Tg) of at least 50° C., at least 60° C., at least 70° C., at least 80° C., at most 200° C., at most 180° C., or at most 150° C. Accordingly, the second polyol containing the cyclic structure may be a hard segment of the polyurethane prepared therefrom.

In addition, the second polyol containing the cyclic structure may include a structure represented by following Chemical formula 9.

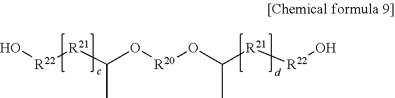

In Chemical formula 9, R²⁰, R²¹, c, and d are defined as in Chemical formula 8.

In addition, R²² may include a unit derived from the diol-based compound, and may be, for example, an alkylene group having 1 to 10 carbon atoms, an alkylene group having 2 to 6 carbon atoms, or an alkylene group having 2 to 4 carbon atoms.

### Preparing Polyurethane (S30)

In the present step, the first polyol having the linear structure, the second polyol containing the cyclic structure, and the isocyanate-based compound are allowed to react with each other to prepare polyurethane.

The isocyanate-based compound may include various materials typically usable in preparing polyurethane, without a special limitation. For example, the isocyanate-based compound may be a polyfunctional isocyanate-based compound including at least two isocyanate groups. Specifically, the isocyanate-based compound may be a 2,4- or 2,6-toluene diisocyanate (TDI), hexamethylene diisocyanate, isoporon diisocyanate, 4,4-dicyclohexylmethane diisocyanate, or 2,2′-, 2,4′- or 4,4′-diphenylmethane diisocyanate (MDI).

The molar ratio among the first polyol having the linear structure, the second polyol containing the cyclic structure, and the isocyanate-based compound may be adjusted, thereby adjusting physical properties, such as flexibility, strength, and compressive strength of the prepared polyurethane.

According to the method for preparing biodegradable polyurethane as described above, as the biodegradable source material and a smaller number of types of monomers are employed, the physical properties of the polyurethane prepared may be easily controlled.

### Biodegradable Polyurethane

In addition, the biodegradable polyurethane of the present disclosure includes a repeating unit represented by following Chemical formula 3.

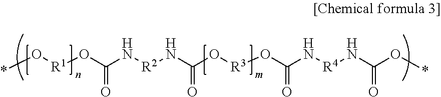

In Chemical formula 3,
R¹ is a linear alkylene group,
Each of R² and R⁴ is an independently substituted or unsubstituted alkylene or alkenylene group,
R³ is an alkylene group containing a heterocyclic group,
n is a real number greater than 10 and less than 200, and
m is a real number greater than 10 and less than 200.

Specifically, the biodegradable polyurethane may be prepared by the above-described preparation method. Accordingly, R¹ may include the first polyol-derived unit having the linear structure, R³ may include the second polyol-derived unit containing the cyclic structure, and R² and R⁴ may include isocyanate-based compound-derived units.

For example, R¹ may include a unit derived from a structure represented by Chemical formula 6. Specifically, R¹ may be represented by following Chemical formula 10.

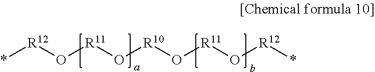

In Chemical formula 10, R¹⁰ may be a unit derived from the bifunctional initiator. For example, R¹⁰ may be an alkylene group having 1 to 15 carbon atoms or an alkylene group having 1 to 6 carbon atoms.

R¹¹ may be a unit derived from the first cyclic monomer. For example, R¹¹ may be an alkylene group having 1 to 10 carbon atoms or an alkylene group having 1 to 6 carbon atoms.

R¹² may include a unit derived from an alcohol-based compound. For example, R¹² may be an alkylene group having 1 to 10 carbon atoms, an alkylene group having 1 to 5 carbon atoms, or an alkylene group having 1 to 3 carbon atoms.

In Chemical formula 10, ‘a’ may be a real number greater than 10 and less than 200.

In Chemical formula 10, ‘b’ may be a real number greater than 10 and less than 200.

Specifically, R³ may include a structure-derived unit represented by Chemical formula 9. Specifically, R³ may be represented by Chemical formula 11.

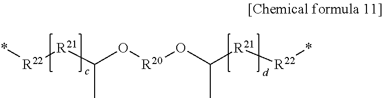

In Chemical formula 11, R²⁰ may be an alkylene group having 1 to 15 carbon atoms or an alkylene group having 1 to 6 carbon atoms. Specifically, R²⁰ may include methylene (—CH₂—), 1,1-ethylene (—CH(CH₃)—), 1,2-ethylene (—CH₂CH₂—), 1,3-propylene (—CH₂CH₂CH₂—), 1,4-butylene CH₂CH₂CH₂CH₂—), or 2,4-butylene (—CH₂ (CH₃) CH₂CH₂—).

R²¹ may be an alkylene group including a heterocyclic group, and may be, for example, a 5-membered ring or a 6-membered ring-containing alkylene group including a heteroatom. The heteroatom may be nitrogen, sulfur, or oxygen. For example, R²¹ may be oxolanyl.

R²² may include a unit derived from the diol-based compound, and may be, for example, an alkylene group having 1 to 10 carbon atoms, an alkylene group having 2 to 6 carbon atoms, or an alkylene group having 2 to 4 carbon atoms.

In Chemical formula 11, c may be a real number greater than or equal to 5 and less than or equal to 100.

In Chemical formula 11, d may be a real number greater than or equal to 5 and less than or equal to 100.

In addition, R² and R⁴ may include units derived from an isocyanate-based compound, and may include aromatic, alicyclic, and aliphatic carbon hydrogen groups.

The biodegradable polyurethane may include 25 wt % of biomass-derived carbon, based on the total weight of the polyurethane. Specifically, the biodegradable polyurethane may include at least 75 wt %, at least 78 wt %, or at least 80 wt % of biomass-derived carbon, based on the total weight of the polyurethane.

The biodegradable polyurethane as described above exhibits an excellent mechanical and/or chemical property, such as impact resistance and heat resistance. Accordingly, the biodegradable polyurethane may be applied as a material in various fields, as a substitute for polyurethane derived from a petrochemical source material.

### Material for Mobility

In addition, a material for mobility according to the present disclosure includes the biodegradable polyurethane. Accordingly, the material for mobility exhibits an excellent mechanical and/or chemical property and has degradability to be eco-friendly.

The mobility may include, for example, a vehicle, an aircraft, a train, a ship, or various mobile robots.

In addition, the material for mobility may be applied to various parts, such as an outer skin material used in a seat, a headrest, or a mat, or an interior part of the mobility.

Hereinafter, the present disclosure will be described in more detail with reference to embodiments. However, these embodiments are intended to help understanding of the present disclosure and the scope of the present disclosure is not limited to these embodiments in any sense.

### EMBODIMENT

### Preparation Example 1: Preparing First Polyol Having Linear Structure

### 1-1: Preparing First Oligomer

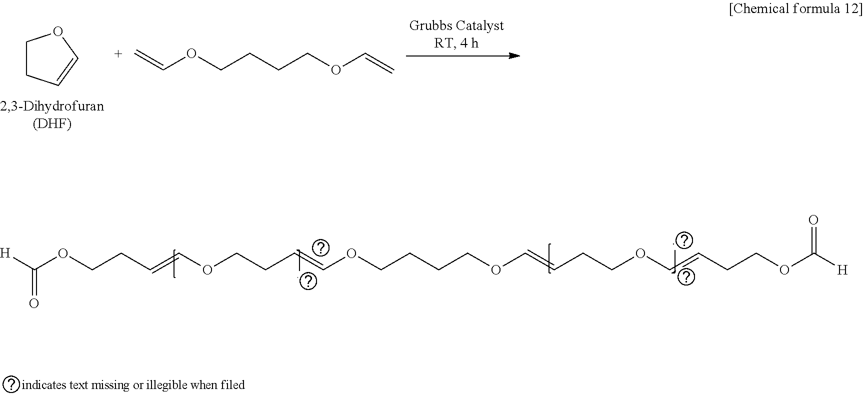

The reaction was performed based on a reaction formula shown in Chemical formula 12.

Specifically, 2,3-dihydrofuran (DHF) was used as the first cyclic monomer, 1,4-bis(ethyleneoxy) butane was used as the bifunctional initiator, and a third-generation grubbs catalyst was used as a grubbs catalyst. In addition, the reaction was made at a room temperature for 4 hours to prepare the first oligomer.

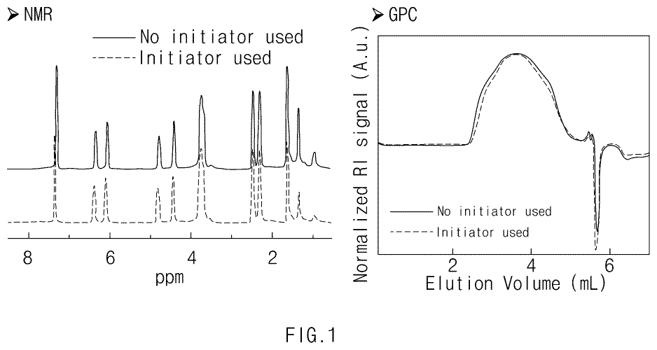

The prepared first oligomer was measured through NMR and GPC, and the measurement result is illustrated in FIG. 1. As illustrated in FIG. 1, it may be recognized that the first oligomer has higher regio-selectivity and a molecular weight precisely controlled.

### 1-2: Preparing First Polyol Having Linear Structure

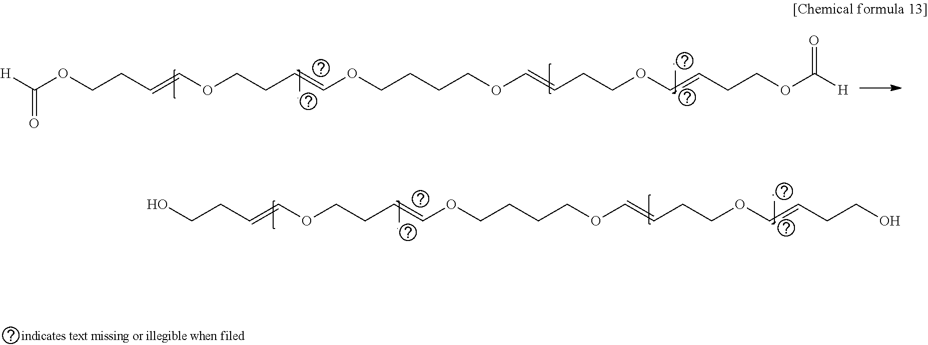

A reduction reaction was performed depending on a reaction formula illustrated in Chemical formula 13.

Specifically, 6 mol of methyl oxy sodium (MeONa) and methanol were added to 1 mol of the first oligomer prepared in Preparation example 1-1, and then reduced at 0° C. for 6 hours to prepare the first polyol having the linear structure.

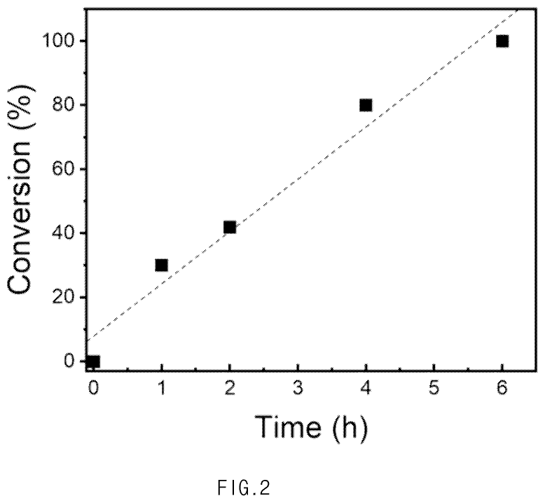

The conversion, at which the first oligomer is converted into the first polyol having the linear structure over a reaction time, was measured by integrating hydrogen present at a terminal of formate, which is reduced over the reaction time, through NMR analysis and the result is illustrated in FIG. 2. As illustrated in FIG. 2, it may be recognized that the appropriate reaction time of the present step was about 6 hours.

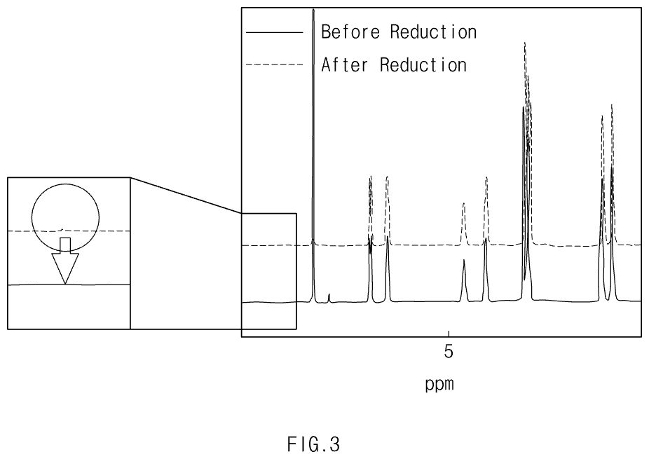

In addition, the prepared first polyol having the linear structure was measured through the NMR, and the result thereof is illustrated in FIG. 3. As illustrated in FIG. 3, it may be recognized that the hydrogen peak in the formate group (—OCHO) disappeared after the reduction reaction, and 100% reduction was achieved.

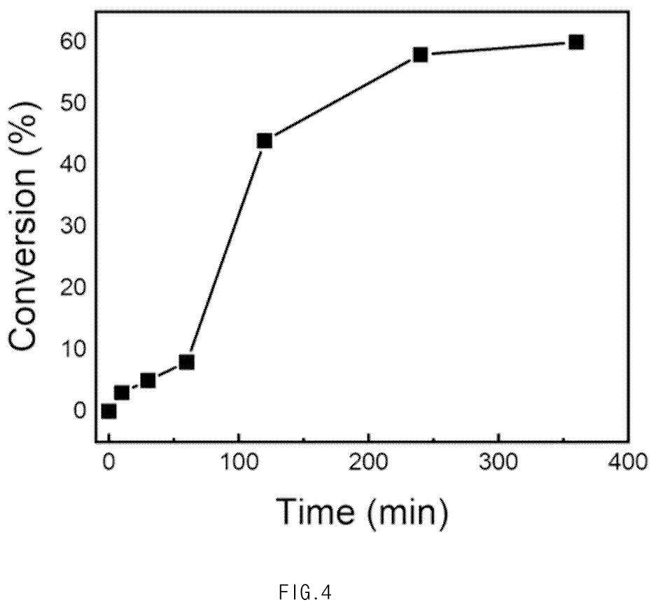

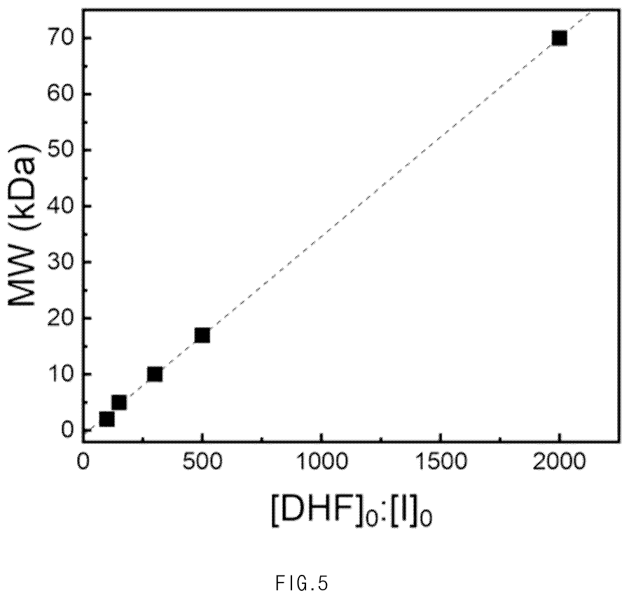

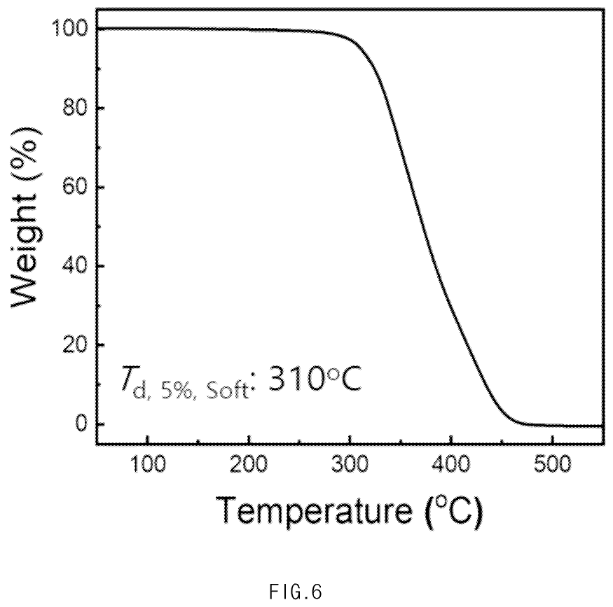

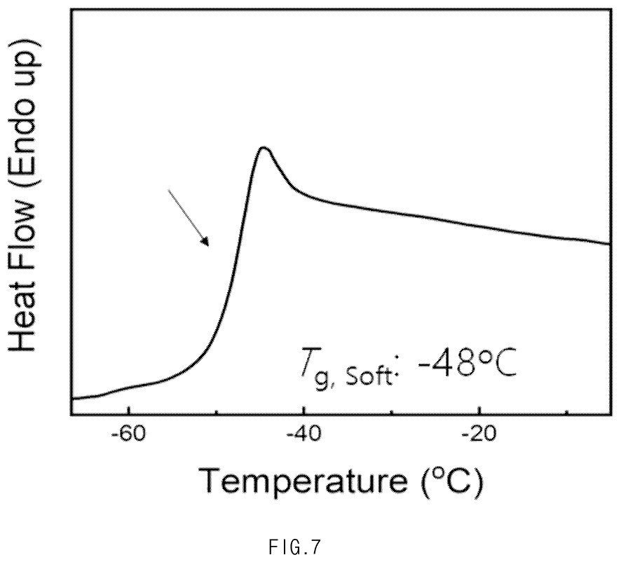

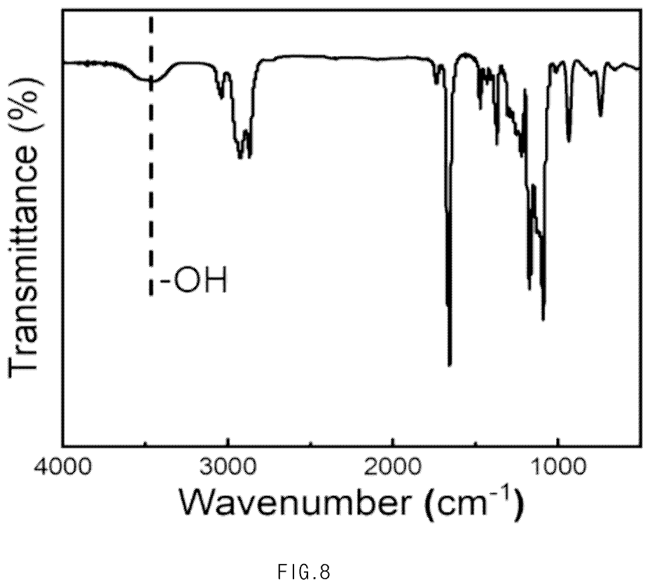

Conversions were measured as a function of the total reaction time (FIG. 4) in preparation examples 1-1 and 1-2, the molecular weight of the first polyol having the linear structure prepared in the ratio of the first cyclic monomer (DHF) and the bifunctional initiator (I) was measured (FIG. 5), the degradable temperature of the first polyol having the linear structure prepared, was measured through TGA (FIG. 6), the glass transition temperature of the first polyol having the linear structure prepared was measured through DSC (FIG. 7), and the FT-IR of the first polyol having the linear structure prepared was measured (FIG. 8), and each of the results is shown in FIGS. 4 to 8, respectively.

### Preparation Example 2: Preparing Second Polyol Containing Cyclic Structure

### 2-1: Preparing Chain Transfer Agent

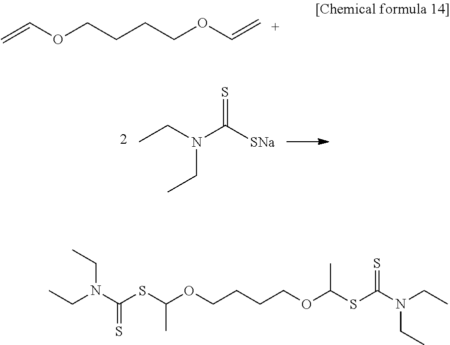

The reaction was performed depending on a reaction formula illustrated in Chemical formula 14.

Specifically, 1,4-bis (ethyloxy)butane was used as the fourth monomer, and sodium diethyldithiocarbamate was used as the thiocarbonylthio-based compound.

### 2-2: Preparing Second Oligomer

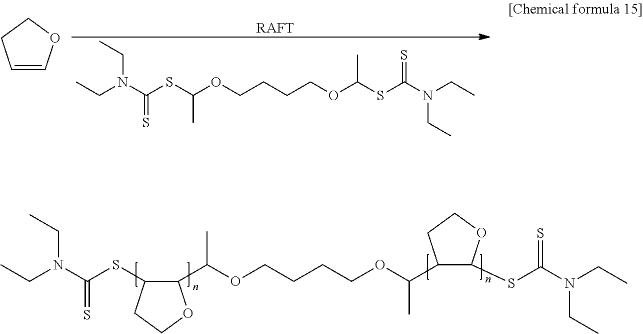

A reversible additional fragmentation chain transfer (RAFT) polymerization reaction was performed depending on a reaction formula illustrated In Chemical formula 15.

Specifically, 2,3-dihydrofuran (DHF) was used as the second cyclic monomer, and the compound prepared in Preparation example 2-1 was used as the chain transfer agent. In this case, for the reaction, the polymerization reaction was initiated by using triflic acid (TfOH), and then performed at −40° C. for 40 minutes to prepare the second oligomer.

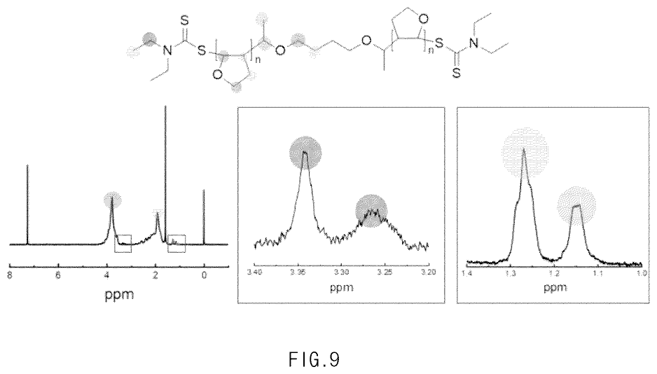

The prepared second oligomer was measured through NMR, and the result thereof is illustrated in FIG. 9.

### 2-3: Preparing Second Polyol Containing Cycling Structure

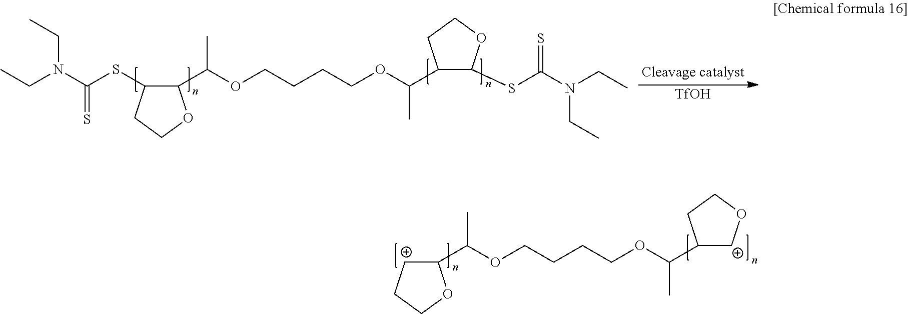

The reaction was performed depending on a reaction formula illustrated In Chemical formula 16.

Specifically, triflic acid (TfOH) was used as an organic acid which is a cleavage catalyst, and the reaction was performed at −40° C. for 1 minute.

Thereafter, a terminal group modification reaction was performed depending on a reaction formula illustrated In Chemical formula 17.

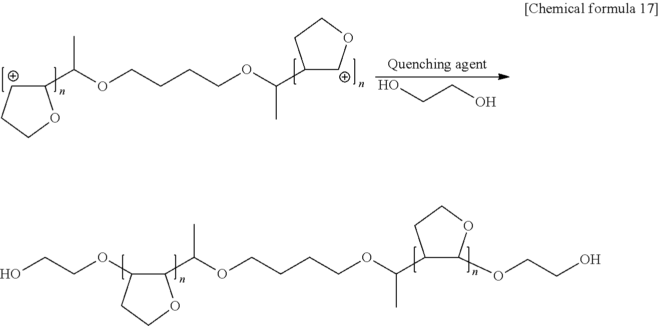

Specifically, ethylene glycol was used as the diol-based compound, ethylene glycol was used as the quenching agent, and the reaction was performed at room temperature for 1 hour to prepare the second polyol containing the cyclic structure.

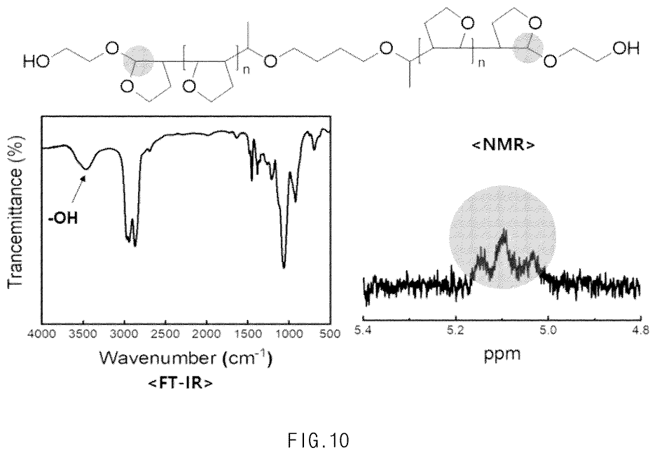

The prepared second polyol containing the cyclic structure experienced the NMR analysis and FT-IR analysis, and the analysis results are illustrated in FIG. 10. As illustrated in FIG. 10, it may be recognized that the hydrogen peak (indicated by a circle) at an acetal position in the second polyol containing the cyclic structure was generated.

### Preparation Example 3: Preparing Polyurethane Using First Polyol Having Linear Structure

Polyurethane was prepared using the first polyol having the linear structure prepared in Preparation example 1 and toluene diisocyanate (TDI).

Specifically, the first polyol having the linear structure, which was prepared in Preparation example 1, and toluene diisocyanate (TDI) were used in a molar ratio of 1:1, and the reaction was performed at 60° C. for 18 hours.

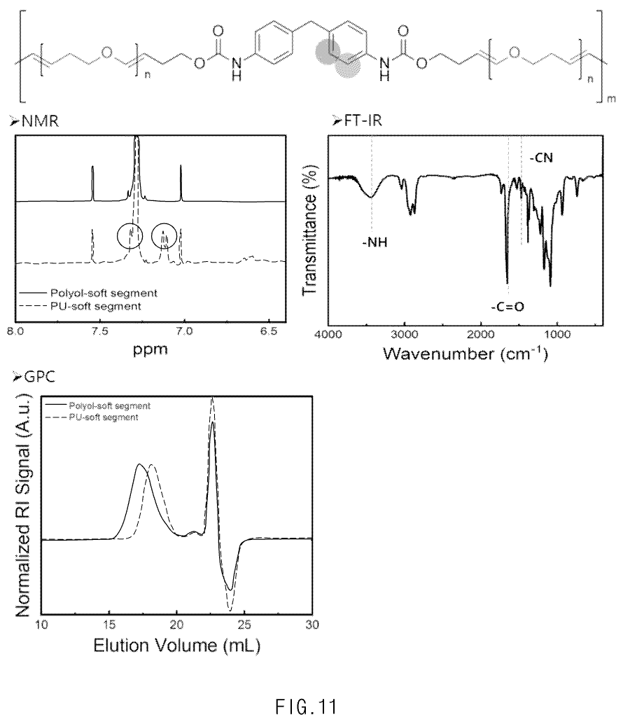

The prepared polyurethane experienced NMR, FT-IR, and GPC analyses, and the results are illustrated in FIG. 11.

### Embodiments 1 to 4: Preparing Polyurethane Foam

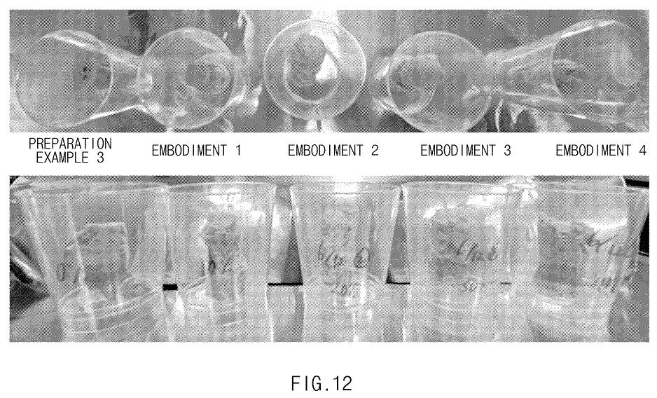

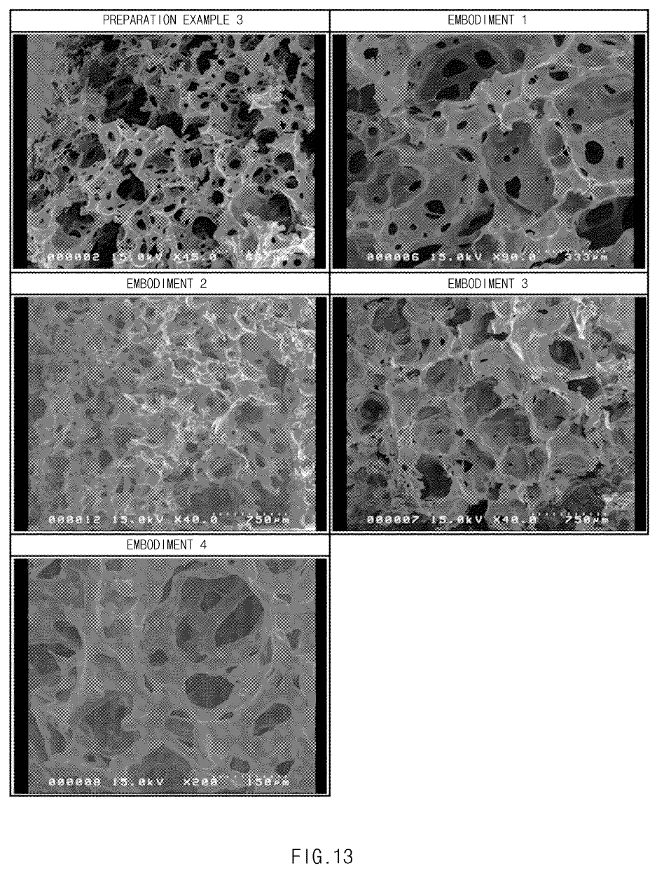

As shown in following Table 1, components were mixed at a room temperature to prepare the biodegradable polyurethane. Specifically, a gelling agent (dimethylcyclohexylamine), a foaming agent (1,1,4,7,7-pentaethyldiethylenetriamine), water, a surface active agent (N-octyl-2-pyrrolidone; NOP), the first polyol having the linear structure according to Preparation example 1 and the second polyol containing the cyclic structure according to Preparation example 3 were put into a flask and mixed at a speed of 2,000 rpm by using a foam mixer. Thereafter, the isocyanate-based compound (2,4-diisocyanato-1-methylbenzene) was put and mixed at a speed of 8,000 rpm for 5 seconds to prepare the polyurethane foam. Photographs of the prepared polyurethane foam are illustrated in FIGS. 12 and 13.

TABLE 1

| | Preparation | | | | |
|---|---|---|---|---|---|
| (weight parts) | example 3 | Embodiment 1 | Embodiment 2 | Embodiment 3 | Embodiment 4 |
| Gelling agent | 6 | 6 | 6 | 6 | 6 |
| Foaming agent | 2.4 | 2.4 | 2.4 | 2.4 | 2.4 |
| Water | 24 | 24 | 24 | 24 | 24 |
| Surface active agent | 20 | 20 | 20 | 20 | 20 |
| First polyol having linear | 830 | 739 | 677 | 577 | 511 |
| structure | | | | | |
| Second polyol containing | 0 | 91 | 153 | 253 | 319 |
| cyclic structure | | | | | |
| Molar ratio of the first | 100:0 | 9:1 | 8:2 | 7:3 | 6:4 |
| polyol:the second polyol | | | | | |
| Isocyanate-based | 185 | 185 | 185 | 185 | 185 |
| compound | | | | | |

As illustrated in FIG. 13, it may be recognized that pores were formed inside the polyurethane foam which is a foamed structure.

### Test Example 1: Evaluation for Physical Properties

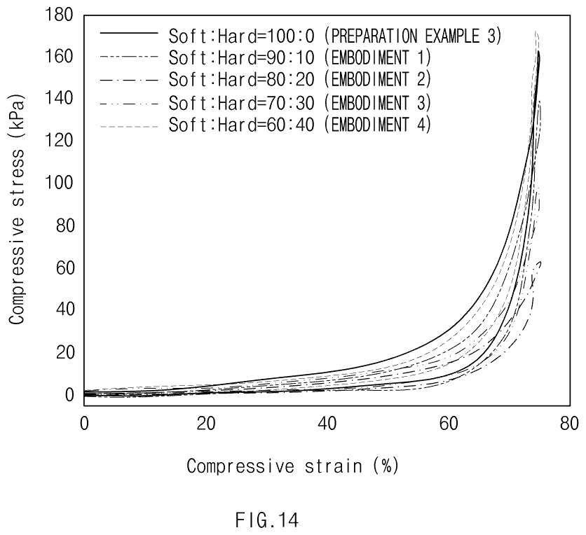

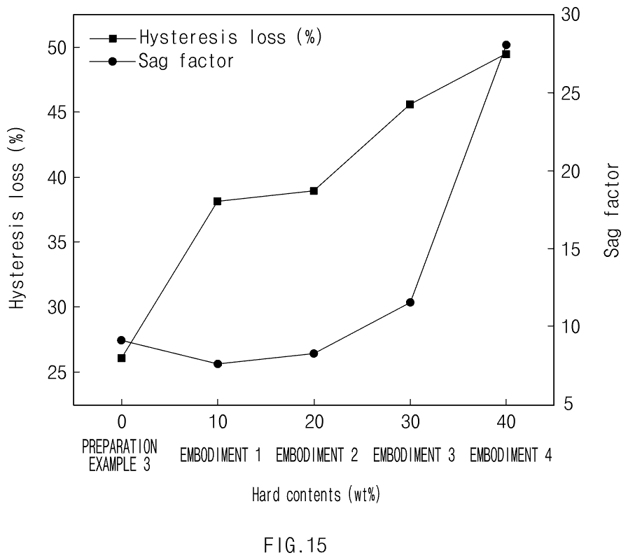

For the polyurethane foams prepared in Preparation example 3 and Embodiments 1 to 4, compressive strength was measured using a universal testing machine (UTM), and the results are illustrated in FIG. 14. Furthermore, for the polyurethane foams prepared, a hysteresis loss and a sag factor were measured, and the results are illustrated in FIG. 15.

As illustrated in FIGS. 14 and 15, it may be recognized that the compressive strength, the hysteresis loss, and the sag factor of the polyurethane foams prepared were varied depending on added amounts of the first polyol having the linear structure and the second polyol containing the cyclic structure, that is, the molar ratio between the first polyol having the linear structure and the second polyol containing the cyclic structure, which are used. Accordingly, it may be recognized that the physical property of the polyurethane prepared may be easily controlled by adjusting added amounts of the first polyol having the linear structure and the second polyol containing the cyclic structure, depending on the purpose of use of the polyurethane foam.

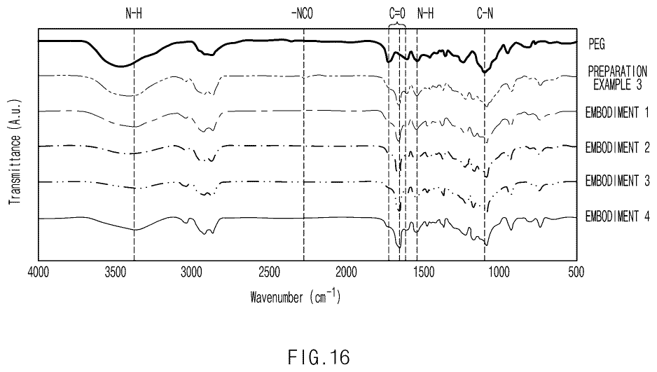

Furthermore, the FT-IR analysis for the prepared polyurethane foam was performed, and the result is illustrated in FIG. 16.

As illustrated in FIG. 16, it may be recognized which the prepared polyurethane foam includes N—H, —NCO, C═O, and C—N groups.

### Test Example 2: Evaluation for Degradability

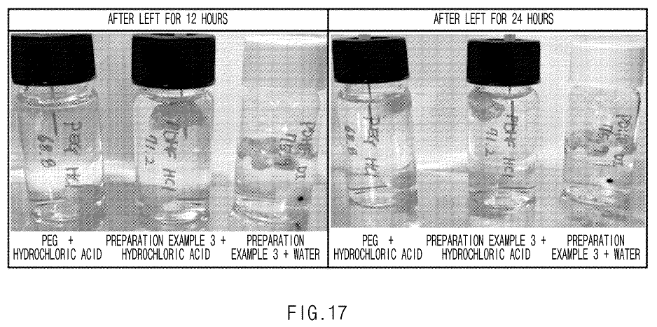

Each of polyurethane and polyethylene glycol (PEG) of Preparation example 3 was put in 0.1 M of aqueous hydrochloric acid solution or water, and left for 12 hours and 24 hours, the degradable degree was visually evaluated, and the results are illustrated in FIG. 17.

As illustrated in FIG. 17, polyurethane and polyethylene glycol (PEG) prepared using only the first polyol having the linear structure according to Production example 3 were not degraded in acid and neutral (water) conditions.

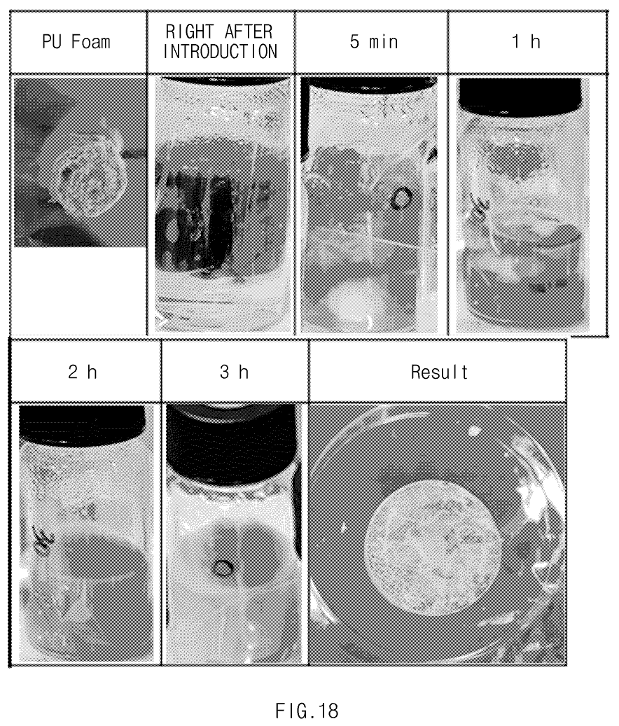

Meanwhile, the polyurethane foam according to Embodiment 1 was put in 0.1 M of aqueous hydrochloric acid solution, and left for 12 hours, and the degradable degree depending on the left time was evaluated with naked eyes, and the result is illustrated in FIG. 18.

As illustrated in FIG. 18, it may be recognized that the polyurethane foam according to Embodiment 1 has biodegradability which allows degradation in an acid condition. It is determined that the polyurethane according to Embodiment 1 has a ketone group (C═O), which is a chemical structure increasing degrading reactivity around an oxygen atom which induces a degradation mechanism. In addition, it is determined that such biodegradability may control a degradation rate by controlling an intensity of exposed acid.

### Test Example 3: Carbon Content

For poly(2,3-dihydrofuran) (PDHF) and toluene diisocyanate (TDI), the content ratios of carbon, bio-derived carbon, and theoretical bio-derived among components were calculated, and the results are illustrated in Table 2.

Specifically, the mixing ratio is the input mass ratio of PDHF and TDI, the content ratio of carbon among components is a value obtained by dividing the amount of carbon by the molecular weight, and the relative carbon ratio is a value which is obtained by multiplying the mixing ratio by the content ratio of carbon among components. In addition, the content of the theoretical bio-derived carbon of PDHF is the percentage of the value which is obtained by dividing the relative carbon ratio of PDHF by the sum of the relative carbon ratio of PDHF and the relative carbon ratio of TDI.

TABLE 2

| | | TDI |
|---|---|---|
| | PDHF (bio- | (petroleum- |
| Classification | derived) | derived) |
| Mixing ratio (composition ratio) | 0.818 | 0.182 |
| Molecular formula | (C₄H₆O)ₙ(n = 214) | C₉H₆O₂N₂ |
| Molecular weight | 15000 | 174 |
| Amount of carbon | 10290 | 108 |
| Content ratio of carbon among | 0.686 | 0.621 |
| components | | |
| Relative carbon ratio | 0.561 | 0.113 |
| Content of theoretical bio-derived | 83.20 wt % | — |
| carbon | | |

As shown in Table 2, it may be recognized that the eco-friendly polyurethane foam having a biomass content of at least 80% was prepared according to the present disclosure, which is different from a conventional petroleum-derived polyurethane foam.

As described above, according to the present disclosure, in the method for preparing biodegradable polyurethane, as the biodegradable source material and a smaller number of types of monomers are employed, the physical properties of the polyurethane prepared may be easily controlled.

In addition, according to the present disclosure, the biodegradable polyurethane exhibits the excellent mechanical and/or chemical property, such as impact resistance and heat resistance. Accordingly, the biodegradable polyurethane may be applied as a material in various fields, as a substitute for polyurethane derived from a petrochemical source material.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A method for preparing biodegradable polyurethane, the method comprising:
preparing a first polyol having a linear structure by polymerizing a first cyclic monomer containing a heteroatom, in presence of a bifunctional initiator;
preparing a second polyol containing a cyclic structure by polymerizing a second cyclic monomer containing a heteroatom, in presence of a chain transfer agent; and
allowing the first polyol having the linear structure, the second polyol containing the cyclic structure, and an isocyanate-based compound to react with each other.

2. The method of claim 1, wherein the preparing the first polyol having the linear structure comprises:
forming a first oligomer containing an ester group at a terminal of the first oligomer by polymerizing the first cyclic monomer containing the heteroatom and being biodegradable, in the presence of the bifunctional initiator; and
reducing the ester group at the terminal of the first oligomer to a hydroxyl group, thereby providing the first polyol having the linear structure.

3. The method of claim 2, wherein the formation of the first oligomer is performed at a temperature of about −20° C. to 60° C. under a grubbs catalyst.

4. The method of claim 2, wherein the ester group at the terminal of the first oligomer includes a formate group (—OCHO), and
wherein the reduction of the ester group is performed using a basic nucleophilic compound.

5. The method of claim 1, wherein the bifunctional initiator includes a linear third monomer including vinyl ether groups at opposite terminals of the linear third monomer.

6. The method of claim 1, wherein each of the first cyclic monomer and the second cyclic monomer is selected from the group consisting of 2,3-dihydrofuran and 3,4-dihydro-2H-pyran.

7. The method of claim 1, wherein the chain transfer agent is represented by the following Chemical formula 1, 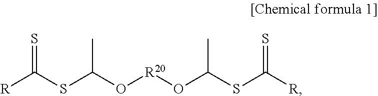
in which R is a substituted or unsubstituted alkyl group, and R²⁰ is an alkylene group having 1 to 15 carbon atoms.

8. The method of claim 1, wherein the chain transfer agent is prepared by allowing a linear fourth monomer containing vinyl groups present at opposite terminals of the linear fourth monomer to react with a thiocarbonylthio-based compound.

9. The method of claim 1, wherein preparing the second polyol having the cyclic structure comprises:
forming a second oligomer containing a functional group, which is represented by the following Chemical formula 2, at a terminal of the second oligomer, by polymerizing the second cyclic monomer containing the heteroatom and being biodegradable, in the presence of the chain transfer agent; and
modifying a terminal group of the second oligomer to a hydroxyl group, 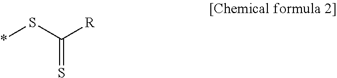
in which, R is a substituted or unsubstituted alkyl group.

10. The method of claim 9, wherein the modifying the terminal group of the second oligomer to the hydroxyl group comprises:
separating the functional group represented by Chemical Formula 2 and present at the terminal of the second oligomer, by allowing the second oligomer to react with organic acid; and
introducing a hydroxyl group into the terminal group of the second oligomer using a diol-based compound.

11. The method of claim 10, wherein the separating functional group is performed at a temperature ranging from about −50° C. to −30° C., and
wherein the introducing the hydroxyl group is performed at a temperature ranging from 15° C. to 35° C.

12. A biodegradable polyurethane comprising:
a repeating unit represented by the following Chemical formula 3, 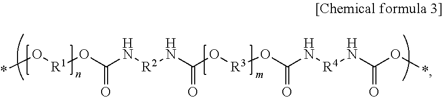
wherein:
R¹ is a linear alkylene group,
each of R² and R⁴ is an independently substituted or unsubstituted alkylene or alkenylene group,
R³ is an alkylene group containing a heterocyclic group,
n is a real number greater than 10 and less than 200, and
m is a real number greater than 10 and less than 200.

13. The biodegradable polyurethane of claim 12, wherein the biodegradable polyurethane contains about 75 wt % or more of biomass-derived carbon, based on a total weight of the polyurethane.

14. A material for mobility, the material comprising the biodegradable polyurethane according to claim 12.

15. A biodegradable polyurethane comprising:
at least 75 wt % biomass-derived carbon, based on a total weight of the polyurethane, and
a repeating unit represented by the following Chemical formula 3, 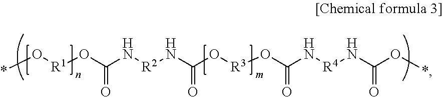
wherein:
R¹ is a linear alkylene group,
each of R² and R⁴ is an independently substituted or unsubstituted alkylene or alkenylene group,
R³ is an alkylene group containing a heterocyclic group,
n is a real number greater than 10 and less than 200, and
m is a real number greater than 10 and less than 200.

16. The biodegradable polyurethane of claim 15, wherein the heterocyclic ring in R³ is selected from the group consisting of a furan ring, a tetrahydrofuran ring, a pyran ring, a thiophene ring, and a pyrrole ring.

17. The biodegradable polyurethane of claim 15, wherein the polyurethane is formed by reacting:
an isocyanate-based compound,
a first polyol having a linear structure, and
a second polyol having a cyclic structure,
each of the first polyol and second polyol being derived from a cyclic monomer containing a heteroatom and having biodegradability.

18. The biodegradable polyurethane of claim 15, wherein the second polyol is prepared by polymerizing a cyclic monomer selected from the group consisting of 2,3-dihydrofuran and 3,4-dihydro-2H-pyran, in the presence of a chain transfer agent.

19. The biodegradable polyurethane of claim 15, wherein each of R² and R⁴ is independently a linear or branched alkylene group having 2 to 8 carbon atoms.

20. A material for mobility comprising the biodegradable polyurethane according to claim 15.
